(19) United States
(12) Patent Application Publication
(10) Pub. No.: US 2006/0008779 A1
(43) Pub. Date: Jan. 12, 2006

(54) Computer method for controlling a display, and graphical tools for on-screen analysis

(76) Inventors: Anne-Marie Shand, Abingdon (GB); David Patrick, Abingdon (GB); Timothy Nuttall, Abingdon (GB)

Correspondence Address: FLYNN THIEL BOUTELL & TANIS, P.C., 2026 RAMBLING ROAD, KALAMAZOO, MI, 49008-1631, US

(21) Appl. No.: 11/173,819

(22) Filed: Jul. 1, 2005

(30) Foreign Application Priority Data
Jul. 2, 2004 (GB) 0414942.3
Jul. 5, 2004 (GB) 0415108.0

(51) Int. Cl. G09B 11/00

(52) U.S. Cl. 434/90; 434/85

(57) ABSTRACT

Three graphical tools are disclosed providing functionalities that can readily cooperate with each other in research, or teaching environments, to provide powerful visual analysis tools, A grid tool is provided which allows a user-defined grid of a selected style to be laid over an image at any location, and which provides a grid reference co-ordinate display. An on-screen ruler tool is disclosed that may be added to an image to provide a clear indication of scale. Also, a calliper tool may be used to read off dimensions of the image that are not discernible from the on-screen ruler. All of these functionalities can therefore be used to greatly enhance the visual impact and effectiveness of a presentation, as well as increasing the amount of useful data that can be extracted from an image.

This invention relates to a computer method of controlling a display to provide on-screen analysis tools, and to on-screen graphical analysis tools themselves.

The presentation of visual information to an audience in a seminar, conference or other teaching environment has benefited greatly from the advent of computers and computer controlled display devices. At the most basic level, high quality images, such as digital photos, or detailed graphics can be displayed on computer monitors as static images or as part of a slide show made up of several images shown in succession. Depending on the set-up of the computing environment, the images may be displayed on several monitor screens to an individual user or to a small number of users, such as in a class room or laboratory, or may be displayed on a large main screen to an audience of many, such as in a lecture hall. Large screens of this type may themselves be monitors, but will typically be simple white-boards on which images are projected under the control of a computer running appropriate software. Such display devices and techniques are well known as effective ways of imparting information, but are limited in that the user remains passively viewing the information rather than interacting it with it in any meaningful way.

Recent developments in display devices, such as interactive whiteboards made by Smart Technologies Incorporated, have however begun to change the way in which graphical data can be captured and viewed. These devices allow a user to project images onto a white-boards which has a control feedback mechanism to the computer projecting the images. Typically, this mechanism is based on touch screen technology. The display of images can be controlled, images themselves can then be modified or created, and software applications can be navigated purely by interacting with the white-board using a specially provided stylus, or purely by touching the board at an appropriate location.

Similar significant developments in image capture devices, such as scanners, digital or video cameras, or digital microscopes such as the QX3 digital microscope from Intel, have made the possibilities for the use of and useful manipulation of computer based images in scientific or educational environments almost unlimited. However, although images can now be more readily created, transferred, stored, and even manipulated, there is still a tendency for such images to be viewed passively. Apart from drawing tools, which allow the image to be modified, there is a very limited number of ways in which a user can interact with the image and gain a feel for what the image represents in the real world outside of the computer. This is particularly true in the case of digital photos or microscope images.

We have therefore appreciated that there is a need for computer-based functionality that readily allows understanding of computer based images at a real world level, and have appreciated that such functionality would be especially valuable in scientific or teaching environments.

The invention is defined in the independent claims to which reference should now be made. Advantageous features are set forth in the appendent claims.

Preferred embodiments of the invention will now be described in more detail, by way of example, and with reference to the drawings, in which:

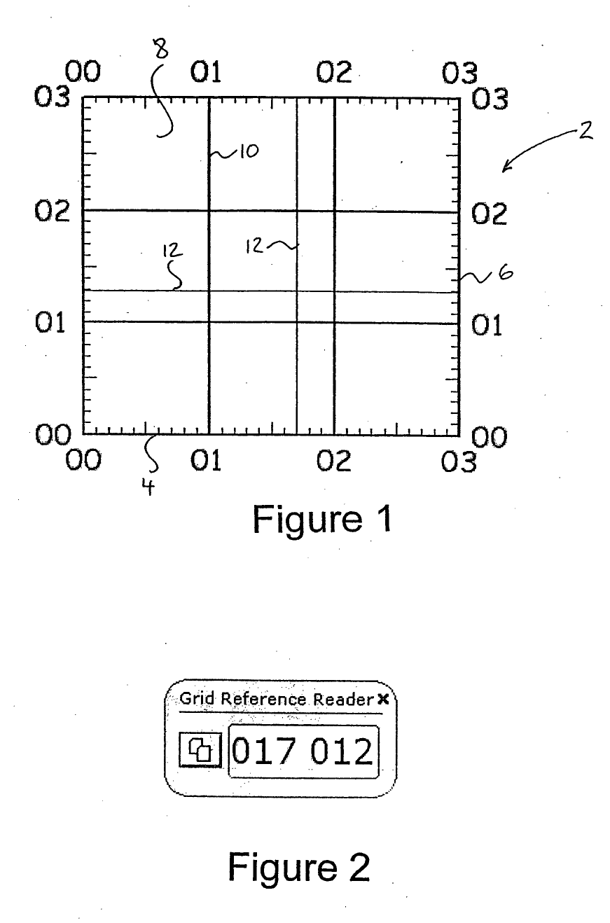

FIG. 1 is an illustration of an on-screen grid object, according to a first aspect of the invention;

FIG. 2 is an illustration of a graphical user interface displaying a grid co-ordinate;

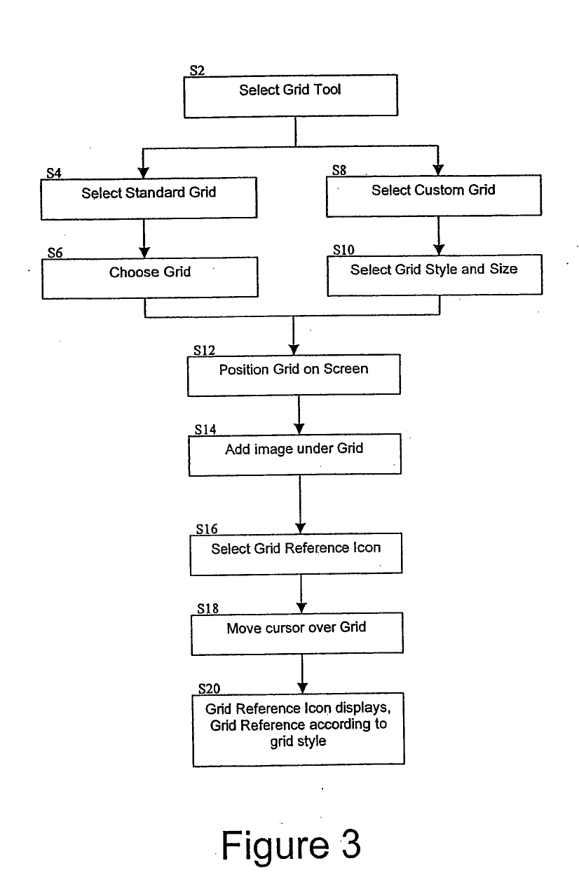

FIG. 3 is a flow chart illustrating the generation and use of the grid object of FIG. 1;

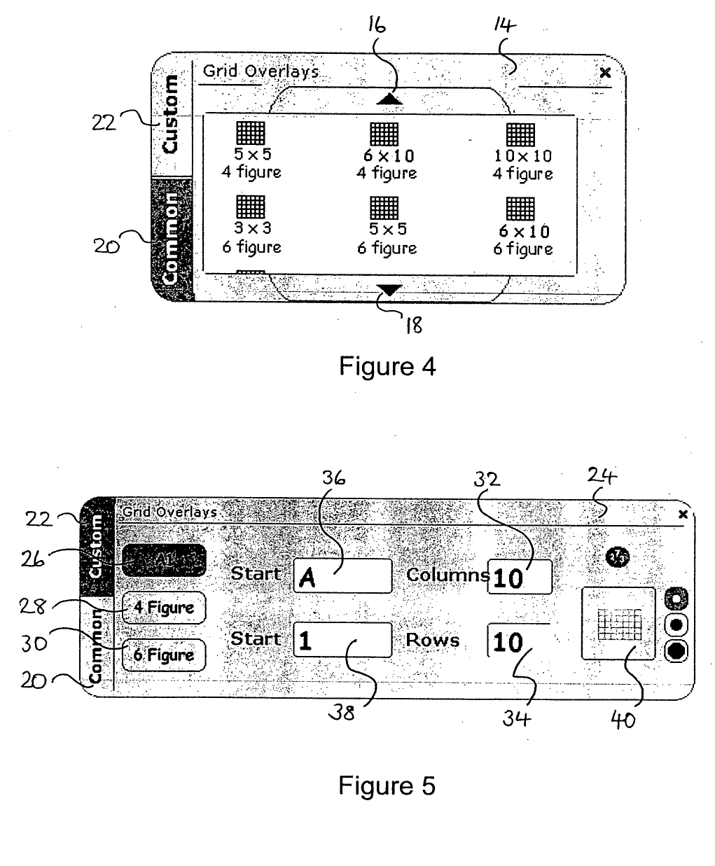

FIG. 4 is an illustration of a first graphical user interface for use in generation of the grid object of FIG. 1;

FIG. 5 is an illustration of a second graphical user interface for use in generation of the grid object of FIG. 1;

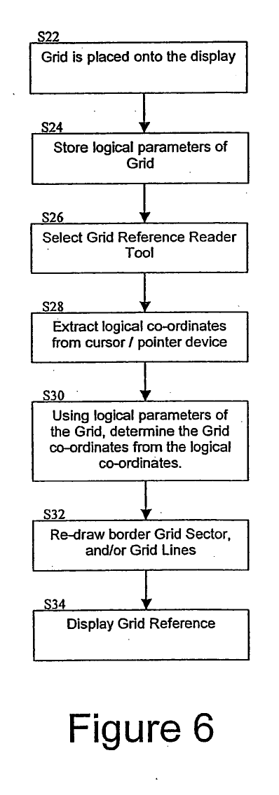

FIG. 6 is a flow chart illustrating the logical processes necessary in controlling the grid object;

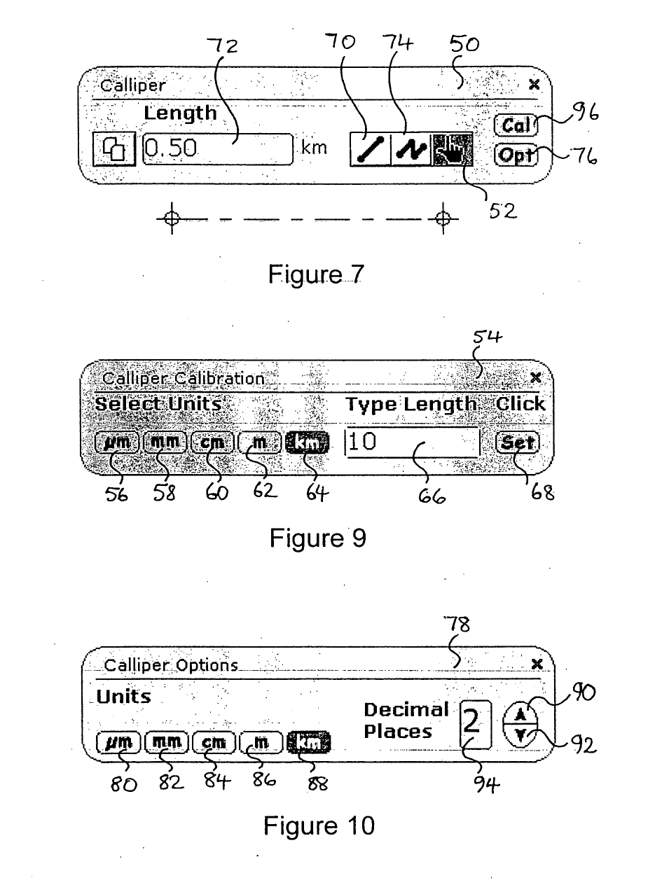

FIG. 7 is an illustration of an on-screen calliper tool, according to a second aspect of the invention;

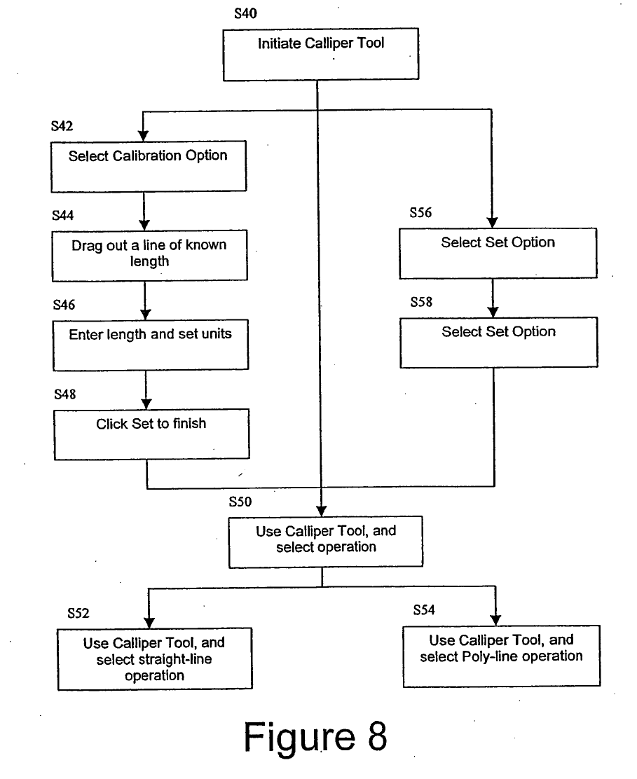

FIG. 8 is a flow chart illustrating the use of the calliper tool;

FIG. 9 is an illustration of a graphical user interface used for calibration of the calliper tool;

FIG. 10 is an illustration of a graphical user interface used to control the operation of the calliper tool;

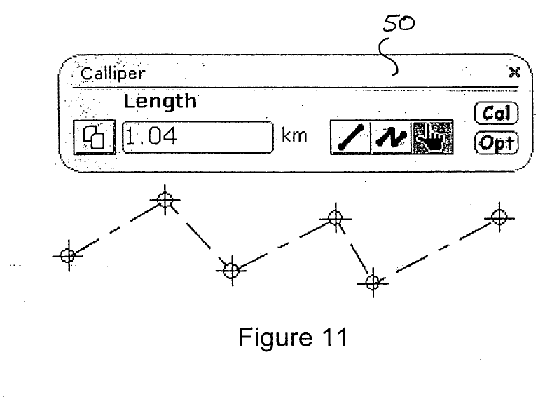

FIG. 11 is a flow chart illustrating in more detail additional functionality of the calliper tool according to the second aspect of the invention;

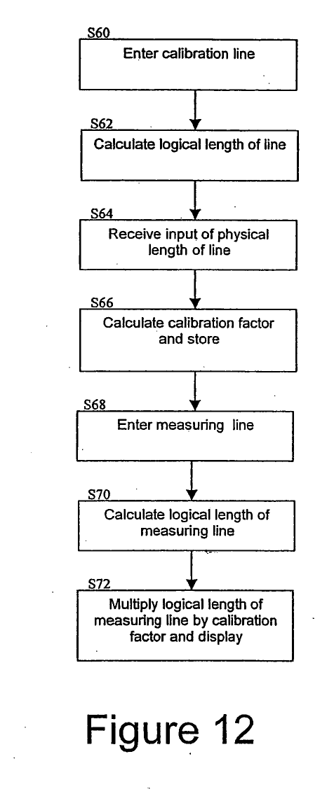

FIG. 12 is a flow chart illustrating the logical processes involved in the operation of the calliper tool;

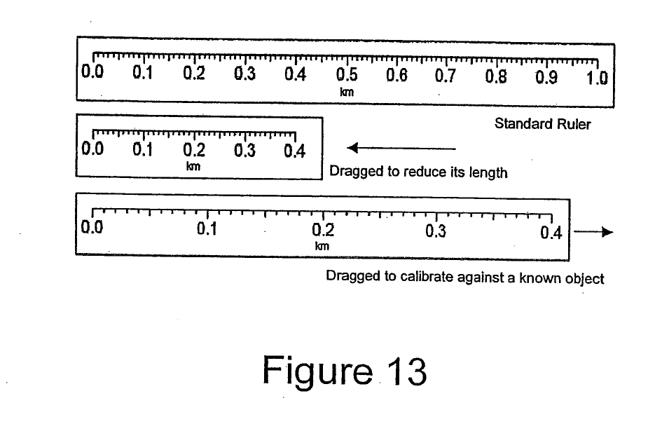

FIG. 13 is an illustration of an on-screen measuring tool according to a third aspect of the invention;

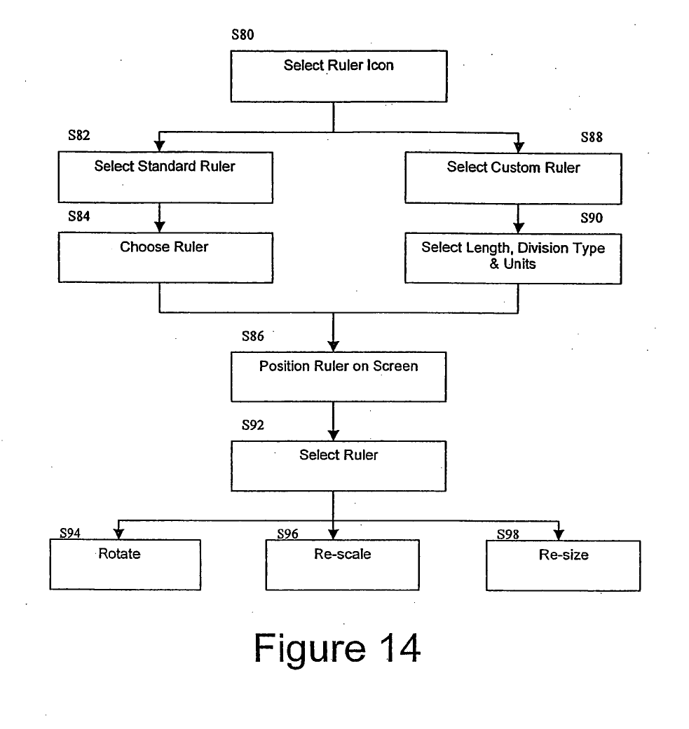

FIG. 14 is a flow chart illustrating the control of the on-screen measuring tool shown in FIG. 13;

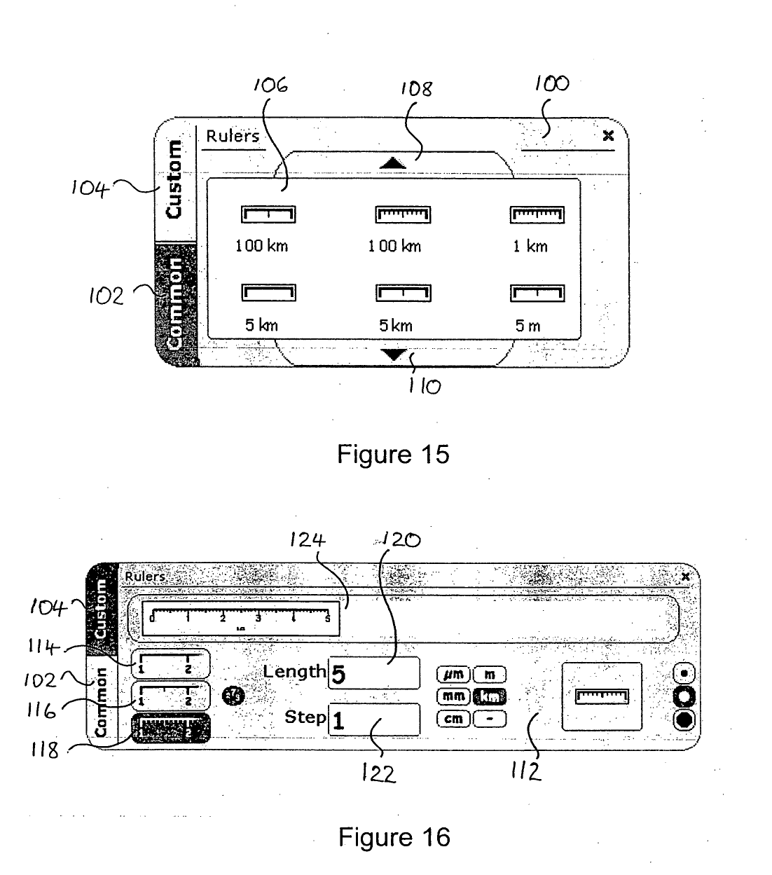

FIG. 15 is an illustration of a first graphical user interface used in the control of the on-screen measuring tool; and

FIG. 16 is an illustration of a second graphical user interface used in the control of the on-screen measuring tool.

A preferred embodiment of the invention in a first aspect will now be described with reference to FIG. 1. This shows a graphical grid object 2 for display on screen. The grid 2 is square in shape and has two principal axes extending in the x and y direction. Both the x axis 4 and the y axis 6 have major axis graduations, labelled 00, 01, 02, 03 etc, as well as minor axis graduations (not labelled). 10 minor graduations are provided for each major graduation. Furthermore, the grid is split into a number of squares 8 or sectors by means of intersecting lines 10 emanating on the axis at each of the major graduations. Finally, a position on the grid given by the co-ordinates 017, 012 is illustrated by the intersecting cursor lines 12. The co-ordinates and the cursor lines may separately or together be referred to as a position indictor for the grid. The grid co-ordinate is preferably displayed in a display window separate to that in which the grid itself is displayed. A preferred display window is shown in FIG. 2, for the grid co-ordinate in the above example.

The area defined by the grid preferably has a transparent background. This allows the grid to be laid over an existing image already on screen, such as a digital photo or graphics. This allows the image to be sub-divided into a number of logically labelled smaller areas, allowing study and analysis of the image to readily take place. Alternatively, the grid may be laid down onto a blank screen, and graphics, such as features of a map, may be generated in the grid afterwards.

The generation, operation and use of the above described grid tool will now be described in more detail, and with reference to FIG. 3.

The grid (‘grid object’) is generated from a grid tool or which may be initially chosen from a specially provided graphical user interface in step S2. As is known in the art, the selection may involve clicking on a dedicated icon in a tool bar, making the selection from a drop down menu, or using a short cut key. This user interface is preferably provided as part of a graphics editing package having conventional graphical tool box functionalities, and the ability to import and export image data.

Two different graphical user interfaces may be provided for generating an overlay grid. As shown in FIG. 4, the first provides a Standard Grid Format selection window 14, or style indicator, presenting a number of standard pre-defined grid formats to the user for selection. A button to access the standard Grid Formats is preferably provided, allowing selection to be made in step S4. Preferably, each format of grid is represented by a graphical icon and several of these are arranged side by side in an array as shown. The icon preferably contains a small graphical illustration of the type of grid format provided, for ease of reference, as well as text information indicating the number of major graduations, and therefore the squares or sectors that the grid has, and the axis labelling style.

For example, the first icon in the top left of the Grid Format selection window, represents a 5×5 grid, with grid references given by four co-ordinates. In FIGS. 1 and 2, the grid reference is given by six co-ordinates.

Scroll indicator arrows 16 and 18 allow more grid format icons to be moved into the selection window, if the window is not large enough to display all of the available formats at once.

A grid line tool may be used to select grids with or without grid lines corresponding to graduations on the axes.

By selecting a grid format icon in step S6, a user may then proceed to drawing step S12, in which the selected grid may be drawn on screen.

Input selector tabs or buttons provided on the left of the Standard Grid Format selection window 14, allow the input method of the Grid to be swapped between Standard and Custom Grids. The graphical user interface comprising the Standard Grid Format selection window 14 is displayed when the Common tab 20 is selected for example, whereas the second graphical user interface mentioned above is displayed when the Custom tab 22 is selected. This selection may be made in step S8 following step S2. The second interface is shown in more detail in FIG. 5 to which reference should now be made.

The second graphical user interface presents a Custom Grid Format selection window 24, having a number of input boxes and fields defining parameters of the grid.

Three selector buttons are provided on the left hand side of the Custom Grid Format selection window 24 allowing a style of axis labelling to be chosen. The first button 26, marked A1, selects an axis labelling style in which the major graduations on one axis (usually the x axis) are labelled with letters of the alphabet, A, B, C etc, and the major graduations on the other axis (usually the y axis) are labelled with numbers 1, 2, 3 etc. This style of labelling may also available through the Standard Grid format selection window 14 described above upon selection of an appropriate icon. However this is not shown in FIG. 4.

The second button 28, marked 4 Figure, and the third button 30, marked 6 Figure, select 4 digit numerical grid references, and 6 digit numerical grid references respectively. The grid co-ordinates shown in FIG. 2 are displayed in the 6 Figure style, and correspond to the ‘6 Figure’ Grid shown in FIG. 1. In this style, the third and the sixth digits of the six figure output are given by the minor graduations.

Alternatively, the ‘4 Figure’ grid is arranged to output a grid co-ordinate rounded off to the nearest major graduation. The co-ordinates shown in FIGS. 1 and 2, would therefore be 01, 02, in the 4 Figure grid style. In the 4 Figure grid style, the moveable cursor grid lines 12 may therefore be omitted.

The Custom Grid format selection window 24 also allows a user to choose the size of the grid, by entering the number of columns and rows in boxes 32 and 34 respectively, as well as choosing the starting number or letter of the labelling on the axes, using boxes 36 and 38. In this case, the rows and columns refer to the rows and columns of grid squares 8 or sectors generated by the grid lines of the major graduations.

For the A1 style grid format style shown as selected in FIG. 5, the starting letter and number shown are the default values of A and 1.

Once, a user has specified a grid style using the input buttons and boxes of the Custom Grid format selection window 24, in step S10, the grid drawing operation is commenced by pressing the draw grid button 40. No such button is required on the Standard Grid Format selection window as, selecting a grid style icon is arranged to automatically take the user to the draw grid function.

Once a grid style has been selected therefore either in steps S4 and S6, or S8 and S10, the grid may be drawn on the screen in step S12 at any position using conventional input techniques. Preferably, a user interactive selector is presented to the user for the selection of a first co-oridnate. The cursor changes shape to indicate that the draw grid function has been selected, A selection action, such as clicking the left mouse button, then selects the current cursor position as an initial co-ordinate for drawing the grid. A grid may then be drawn for example, by dragging the cursor to a second position indicating a second co-ordinate point, the first and second co-ordinate points being taken as indicating opposing corners of the grid. A draggable grid may be displayed between the initial co-ordinates and the current cursor position, becoming a fixed grid when the second position is selected, in order to aid the user in the drawing process. Of course, other methods of generating the grid on screen may also be used. Each of these methods, involve the generation of a boundary shape for the grid by a boundary shape generator. The boundary shape defines the position and shape of the grid on screen and may be visible to the user or not. Boundary shapes and their generation are known to those skilled the art, and so will not be explained in more detail.

Once the grid has been drawn on the screen, it may be moved, resized, rotated or deleted, like any normal graphics object in existing drawing packages. Selecting the grid object on screen, say by double clicking of the left mouse button, or a single click of the right mouse button, may also allow the grid to be edited by bringing up the custom Grid Format selector window 24. Any changes to the grid parameters shown in the selector window 24 for the selected on-screen grid, are then applied to the grid once the draw button 40 is selected.

As mentioned earlier, the grid object preferably has a transparent background, so that it may be drawn over an image already positioned on screen. If, the grid has been drawn on a blank screen however, in step S14 the user may choose to add an image or add graphic detail.

Once the grid object is displayed on screen, selection of a Grid Reference display button in step S16, results in the Grid Reference Reader window shown in FIG. 2 being displayed on screen. If the screen cursor is already positioned within a grid object, then the intersecting cursor position lines 12, and a border of different colour for the grid square in which the cursor is positioned may also be displayed.

The user may then interact with the grid by moving the screen cursor over the grid object in step S18. By doing so, position of the screen cursor is automatically displayed with reference to the grid over which the cursor is positioned in step S20. The display style of the grid co-ordinate is made to automatically correspond to the axes style chosen in steps S4 and S6, or S8 and S10.

If more than one grid is displayed on screen, preferably only the appropriate grid reference for the grid over which the cursor is positioned is displayed.

The co-ordinate display style also changing as the screen cursor is moved from grid object to grid object.

The interaction of the grid with the underlying screen layout and screen cursor will now be explained in more detail, and with reference to FIG. 6. In step S22, a new grid is placed onto the display area. The logical grid parameters, such as the grid origin, the grid boundary shape defining the axes, and the axes style are then all stored in memory for that particular grid object in step S24. Each grid stored in memory is given a unique identifier so that it can be individually addressed.

It will be appreciated that for the rectangular grid generation tool defined above, the grid origin position and the grid boundary shape can be readily calculated from the initial and second co-ordinates input during the grid drawing step S12. For example, if the initial and final grid co-ordinates specify the screen co-ordinates of opposing corners of the grid (x1, y1) and (x2, y2) respectively, then the grid origin, assuming it is at the bottom left of the grid, will be given by the co-ordinates (xₘᵢₙ, yₘᵢₙ) where xₘᵢₙ is the smallest value in the set [x1, x2] and yₘᵢₙ is the smallest value in the set [x2, y2].

Additionally, from the initial and second co-ordinates, the co-ordinates of the lines defining the boundary of the grid can be calculated in a straightforward fashion. From these two co-ordinates therefore, the logical position of the grid on screen can be easily stored.

In step S26, it is then assumed that the Grid Reference Reader tool button is selected. This causes the Grid Reference Reader window to be displayed on the screen.

In step S28, the logical co-ordinates specifying the position of the on-screen cursor is then read from the appropriate location in memory in known fashion, and in step s30 these co-ordinates are compared with the co-ordinates of the lines defining the boundary shape of each grid, to determine whether or not the cursor is presently positioned over a grid or not. If the cursor is found to lie within the boundary shape of a grid object, then the logical co-ordinates of the cursor are converted into grid co-ordinates, using the grid boundary shape information and the axes style information stored in memory.

In step S32, intersecting grid lines may then be rendered onto the grid, depending on the grid style, to indicate the present cursor position. Also the border of the grid square in which the cursor is positioned may also be rendered in a different colour.

In step S34, the appropriate grid co-ordinates are then displayed in the Grid Reference Reader window, in a format corresponding to the axes of the grid. The grid format information is obtained by checking the grid parameters stored in memory,

If the co-ordinates of the on-screen cursor indicate that it lies in the boundary shape of more than one grid object then a number of processing options are available. Preferably, only the grid reference for the most recently created grid is displayed, with the co-ordinates for the underlying earlier grid being temporarily ignored. The order in which the grid objects were created can easily be read with reference to the grid parameter information that is stored in memory.

Alternatively, the grid reference for each grid object may be displayed in the Grid Reference Reader window with a clear indication of the grid to which it relates.

The grid object and grid tool described therefore provide a useful reference tool for grappling with computer based images. In step S14 for example, an image from a digital camera or digital microscope could be loaded into the graphical package and placed on the screen in a desired position. The grid would then provide an overlay of co-ordinates to make visual analysis of the image, and discussion of the content of the image easier. Also, the moveable cursor gridlines, and the coloured grid square border, allow a particular grid position indicated by the on-screen cursor to be displayed more clearly.

As the grid is moveable, and can be generated from any initially selected position co-ordinate, ensuring correspondence between an image and the grid is straightforward.

Alternatively, in a teaching environment, the grid object may be used as the basis of a geography based or creative based lesson, with students adding map features to the grid such as roads, villages, rivers etc. In this context, the grid solely provides an enjoyable and useful addition to a toolbox of drawing tools. The cursor gridlines, and the Grid Reference reader, however provide a tool for inexperienced map readers to practice reading and giving co-ordinates for map features.

The grids described so far have all been square or rectangular in shape, as this shape is the most useful for the majority of applications. However, it will be appreciated that sometimes grids of different shapes will be desired.

A circular grid for example, could be generated for use with polar projections of the earth. The initial co-ordinate captured in the grid generation step S12 may then define the centre of the grid, and the second co-ordinate a position on the grid line with maximum circumference. Grids according to other map projections could also be used.

More complicated shaped grids may also be developed Such as parallelogram, or trapezium shaped grids. A parallelogram shaped grid for example may be used to map onto part of an image which is shown as receding into the distance. The grid lines could then follow the converging boundaries of the object in the image and represent co-ordinates on the object in the image itself rather than on the screen. Such a grid may be easily generated by the user, by selecting an initial, second, third and fourth co-ordinates to define each respective boundary line of the grid.

Alternatively, a grid may be added to an object in an image by determining the boundaries of the object and mapping the grid boundaries onto the object boundaries. Techniques of analysing images and determining image outlines are well known and so will not be described here. Such grids could then be generated merely be selecting an initial co-ordinate lying within the object in the image. Applying a grid in this way clearly may not be appropriate if the image object does not have a regular quadrilateral, circular or elliptical shape.

In addition to the Grid Reference tool described above, the invention provides, in a second aspect, a tool for measuring a physical distance on a digital image. In this context, ‘physical distance’ is taken to mean a distance in the real world, distinguishable from a ‘logical’ distance on the image itself. A logical distance for example may be expressed by the pixel difference between a start co-ordinate and an end co-ordinate. If the image is of the petal of a flower for example, the petal may have a logical length of say 100 pixels. In real life, however the petal may have a physical length of 2 cm.

We have appreciated that it would be advantageous to allow real-world or physical dimensions associated with an object to be readily measured and displayed to a user, who only has a digital image of that object for reference. In this way, the user can easily grasp the dimensions of an object featured in the image, and the image can be used more meaningfully.

The measuring or calliper tool, according to the second aspect of the invention will now be described with reference to FIG. 7.

FIG. 7, shows a graphical user interface 50, providing functionality for a user to measure a physical distance on an image. The graphical user interface takes the form of a display window in which a number of selector buttons and fields are provided use of the calliper tool shown in FIG. 7 will now be described in more detail with the aid of the flow chart shown in FIG. 8.

Firstly, in step S40, the calliper tool is selected for use, from a menu option, by clicking on a dedicated tool box icon, or using a keyboard short-cut, as is known in the art. The calliper tool may also be launched automatically in response to program code.

First of all the calliper must be calibrated for use with the particular image. This is achieved in step S42 by selecting calibration button 52 (showing a hand icon), which changes the screen cursor to a cursor for drawing a line, such as is indicated under the window 50. In step S44, the user then clicks on screen, using a known input device such as a mouse, to select the starting co-ordinate of a calibration line. Moving the cursor after the first click drags out a line from the start co-ordinate to the present position of the cursor. Clicking again with the input device fixes the line in place on the image, and therefore sets an end co-ordinate for the line. The graphical user interface therefore provides a first input mechanism for receiving a calibration distance line.

A calliper calibration window 54, shown in FIG. 9, is then displayed instead of, or in addition to the Calliper tool window 50. The calibration window 54, has a number of buttons 56, 58, 60, 62, 64, which select input units μm, mm, cm, m and km respectively. More buttons for different measurement units may also be provided. A user selects in step S46, a measurement unit, and then enters a physical distance in box 66. This physical distance signifies the physical length of the line just drawn on the image. This corresponds to a second user input mechanism provided by the graphical user interface.

Selecting the set button 68 in step s48, then calibrates the logical length of the calibration line input in step S44 to the physical length input in step S46. A first comparator can determine the length of the calibration line on screen in pixels or screen distance in known fashion. The calibration line that was drawn by the user, may then be removed from the screen The physical length of the calibration line may be known by the user from his own measurement of a part of the object in the image. For example, in the example of the flower mentioned above, the user may have measured the length of the petal at 2 cm when the image was taken. Thus, if the calibration line is drawn across the length of the petal on screen, and the length 2 cm entered in box 66, the calliper tool will be correctly calibrated to the dimensions of the flower.

In scientific environments, it may be good practice to include in the image something of known dimensions when the image is taken. Thus, a ruler placed next to an object when the image of the object is captured, will provide the necessary length information for reference. In this case, the calibration line can be drawn directly onto the image of the ruler, and the corresponding physical length can be read directly off the ruler. If the image is read from a digital microscope, the output image may already have a physical length scale indicated.

Once the calliper tool is properly calibrated, it may be used in step S50 to provide an indication of the corresponding physical distance for any logical distance on the image. The input of the distance involves a third input mechanism provided by the graphical user interface. In step S50, a user may first for example select the straight-line distance tool button 70. In doing so, the user is able to draw a straight line anywhere on the image in step S52 using appropriate operations of the input device. Once the line has been drawn, the corresponding ‘physical’ distance of the line is displayed in the output field box 72. The line may of course be drawn in any direction, and on any part of the image. A second comparator once again determines the screen length of the line that has been drawn. Thus, an indication of the dimensions of any part of the object shown in the image can be given.

A poly-line distance tool button 74 is also available, for selection in step S74, and is illustrated in FIG. 11.

If this tool is selected in step S50, then the user may in step S54 draw a series of joined straight lines, called a poly-line, on the screen. This is illustrated underneath the calliper tool window 50. The poly-line contains a start co-ordinate, an end co-ordinate and one or more intermediate co-ordinates, and a straight line connects the start co-ordinate to the first intermediate co-ordinate, the first intermediate co-ordinate to the next intermediate co-ordinate, and so on until the end co-ordinate is reached. The end co-ordinate may be indicated by an operation of the input device such as a double click to distinguish its input from that of an intermediate co-ordinate.

Once an end co-ordinate has been input, the calliper displays the total physical length of the poly-line, given by the sum of the physical lengths of each of the connecting lines.

Additionally, the poly-line may be used with curved line segments rather than straight lines. Bezier curves are preferred. In practice, once the poly-line has been completed, a line section can be selected, using the on-screen cursor for example, causing control points or handles to be displayed on the section. Using the on-screen cursor, these can then be dragged, manipulating the straight line into a curved shape. Just one or each section of the poly-line can be curved as desired.

The poly-line tool is useful to calculate the lengths of perimeters on image objects. A particularly advantageous application in this context therefore is to use the tool to calculate the perimeter dimensions of polygonal shapes aiding students in a lesson introducing these shapes and the relationships between their sides.

It may also be used in combination with a map image to display the total length of a particular route. Of course such routes are hardly ever described by a single straight line. However, they may typically be broken down into a number of straight line sections. Furthermore, if the calliper tool is used with a map image, calibration of the calliper to the map is straightforward, as the calibration can be performed with respect to the scale indicated on the map.

The output style of the calliper can be modified in step S56, by selecting the ‘Opt’ button 76, from the Calliper tool window 50, when the calliper tool is first started in step S40, or at any time during subsequent use.

Selecting this button brings up the Calliper Options window 78 on the display, as shown in FIG. 10. The window has a number of buttons 80, 82, 84, 86 and 88, indicating μm, mm, cm, m and km respectively, for the preferred units of the output physical length. The number of decimal places to which the physical length is output may also be controlled with arrows 90 and 92, with the present number of decimal places displayed in box 94.

Although the calibration process is preferably started automatically when the calibration tool is used for the first time, the calliper may be recalibrated at any time by selecting the calibration button ‘Cal’ 96 from the main tool display window 50. This allows the user access to Calliper calibration window 52, and steps S42 to S48.

The operation of the calliper tool will now be explained in more detail with reference to FIG. 12. In step S60, the calibration button is selected, and a calibration line of known physical length is drawn on screen. In step S62, the logical distance of this line is calculated from the start and end co-ordinates of the line by a first comparator, and may be measured in pixels for example. In step S64, the physical length of the line is received from the user input into box 66, and in step S66, a calibration factor is calculated and stored in memory. The calibration factor is the input physical length divided by the logical length of the line.

Subsequently, if a measuring line, that is a line whose physical length is to be determined, is input in step S68, then in step S70, the logical length of that measuring line is calculated from the start and end co-ordinates by a second comparator. Once the logical length of the measuring line is known, calculating the physical length is then a matter of multiplying the logical line length of the measuring line by the calibration factor in step S72.

Thus, the physical length of the newly input measuring line can be displayed in field 72 as shown in FIGS. 7 and 11.

The invention, in a third aspect, also provides an on-screen ruler tool. This is shown in more detail in FIG. 13. The ruler can be sized and calibrated to an object of a known size in an on-screen image. The ruler can then be moved and rotated in order to measure other objects on screen. The Ruler is particularly suitable for teaching environments where it can be used on images captured from a digital microscope for example in the teaching of science, or for use with maps and plans in the teaching of geography.

The operation of the Ruler tool will now be described in more detail with reference to the flow chart of FIG. 14. Firstly, in step S80, the Ruler tool is selected from a dedicated icon on screen, a menu option, or using a keyboard shortcut. This causes Ruler style selection window 100, as shown in FIG. 15, to be displayed on screen. The Ruler style selection window 100 has two buttons on its left edge, marked ‘Common’ 102, and ‘Custom’ 104 respectively. If the Common button is selected by the user, in step S82, then the Ruler style selection window 100 becomes the Standard Ruler style selection window 106 shown in FIG. 15. Preferably, the form of Ruler style selection window 100 defaults to this window in any case.

The Standard Ruler style selection window 106 displays an array of icons representing different standard ruler styles that are available for selection. Each style differs in the length of the ruler, and the number of graduations displayed on the ruler. For example, the icon in the top left of the Standard Ruler style window 106, represents a ruler of 100 km in length with only major graduations, say every 10 km. The next icon on the right represents a ruler of length 100 km, with both major and minor graduations, say at 10 km and 1 km respectively. Although, all of the icons shown in the window 106 are in metric units, imperial units may also be used.

Scroll arrows 108 and 110 on either side of the array of icons allow more styles to be displayed in the Ruler Style selection window, where these are available and the window is too small to display all available styles simultaneously.

A user may therefore select a style of ruler from those available in step S84, and position this on the screen in step S86. The positioning may be achieved using an input device such as a mouse, cursor keys, or may simply be placed in a default position following selection.

If the ‘Custom’ button 104 is selected in step S88 after the Ruler selection tool is launched in step S80, then the Ruler Style selection window 100 becomes the Custom Ruler selection window 112 shown in FIG. 16. Using this window, the user has more flexibility over the style of ruler that is generated.

Buttons 114, 116 and 118 on the left side of the window 112 allow different graduation styles to be selected. Button 114 for example provides a major graduation each unit, button 116, an additional minor graduation each half unit, and button 118, an additional minor graduation every tenth of a unit.

Similarly, box 120 allows the total range or span of the ruler to be input as a number, and box 122 allows the step size of the graduation to be set. For example, a step size of 2 would cause a major graduation to be set on the ruler every 2 units of length. 5 buttons on the right of these field boxes allow the user to set the measuring units that are to be used, such as μm, mm, cm, m and km. The up-dated format of the ruler is shown in a display part 124 of the Custom Ruler selection window 112.

Although, not shown vertical rulers, or rulers set at a particular angle may also be selected by means of the Standard or Custom Ruler Style Selection windows.

Once the style of the ruler has been set to the satisfaction of the user in step S90, the draw ruler tool is used to complete the style selection and place the ruler on the screen as before in step S86.

Once a ruler has been placed on the screen, it may then be moved, re-sized, or rotated. Resizing in connection with the on-screen ruler has two meanings. Firstly, it may mean resizing the on-screen logical length of the ruler keeping the total span or range of the ruler constant, such that the size of the units of measurement is increased or reduced accordingly. Secondly, it may mean increasing or decreasing the range or span of the ruler by adding or subtracting units of measurement. In this last case, the size of the measurement units will not change, but the logical length of the ruler on-screen will. This latter meaning shall be referred to as re-scaling the ruler.

To conveniently accommodate both of re-sizing and re-scaling functions, if an on-screen ruler is selected in step S92, then it is displayed on the screen with pre-determined locations of the ruler made available for interaction with the cursor. These locations may be indicated for example by sizing and rotation handles displayed at the periphery of the ruler. In addition or instead of graphical indications such as handles, the shape of the cursor may change when hovering over the appropriate location for a function to be accessed, the changed cursor shape indicating that that function is available. By clicking on the appropriate handles, or by making a selection operation with the cursor when it is indicating an available function, the on-screen ruler can be manipulated by dragging the cursor in a desired direction.

Preferably for example, rotation handles are provided at the corner of the ruler in known fashion, such that the angle of the ruler on screen can be altered. The ruler may be rotated as described above by holding the cursor over the corner located rotation handles, in step S94, such that it changes into a rotation cursor. Dragging the cursor then causes the ruler to rotate with it.

In changing the display angle of the ruler, the orientation of the numbers and graduations marking the scale on the ruler will also rotate. Preferably, however, when the ruler becomes vertical or close to vertical the numbers marking the graduations on the ruler may be adjusted so that they are displayed the right way up, as if the ruler were horizontal, rather than angled as after rotation. This has been found to improve usability of the ruler, as the user does not have to tilt their head to read the numbers.

Additionally, if the ruler is rotated still further, so that it is effectively upside down compared to its original horizontal orientation, then preferably, the numbers and graduations are flipped to be the right way up once again. Of course, both of these measures to improve the readability of the ruler as it is rotated may be turned off or on as desired,

Re-scaling of the ruler to alter its range by adding or subtracting units of measurements is preferably achieved by holding the cursor over the side edge of the ruler in step S96. In doing so, the cursor changes into a re-scale cursor. If this cursor is moved in the length-wise direction of the ruler, the range of the ruler is altered.

Alternatively, in step S98, if the cursor is held over re-size handles positioned on the side edge of the ruler, then it changes into a re-size cursor. Moving this cursor resizes the ruler on screen such that the range is constant.

The three aspects of the invention described provide functionalities that can readily cooperate with each other in research, or teaching environments, to provide powerful visual analysis tools. A speaker leading a visual presentation of data or image, can use the grid overlay tool to divide up a large image into regions for further analysis or reference. The grid reference reader can then be used to display reference co-ordinates of the overlay grid. Furthermore, the on-screen ruler tool may be added to the image to provide a clear indication of scale on the image, while the calliper tool may be used to read off dimensions of the image that are not discernible from the on-screen ruler. All of these functionalities can therefore be used to greatly enhance the visual impact and effectiveness of a presentation, as well as increasing the amount of useful data that can be extracted from an image.

In a classroom teaching environment, the tools can be used by students in a scientific or geography based application, such as the Easiteach Science and Geography Modules of Research Machines Plc. In science applications, the tools can be used as described above to allow students to analyse images displayed on screen. In geography applications, the grid and ruler tools may be used to generate maps for study and use, the calliper tool being used to read distances off the map.

Although preferred embodiments of the invention have been described to illustrate the invention these are not intended to be limiting to the scope of invention defined by the claims. Additionally, although first and second input mechanisms and comparators for example have been described it will be appreciated that these are not necessarily exclusive of each other, and that they may in fact be implemented as different functions of a single element.

Also, although the invention has been described with reference to software processes, it will be appreciated that these could be implemented in hardware if desired.

1. A computer program product having a computer readable medium on which code is stored for controlling a display device of a computer, the display having a moveable on-screen cursor for selecting and editing parts of the display, wherein when the code is executed on the computer the computer is caused to perform the steps of:
receiving an initial display co-ordinate;
creating a boundary shape which includes the initial co-ordinate;
creating axes along at least two non-parallel sides of the boundary shape, the axes having graduations;
controlling the display to show the axes;
receiving the position of a user controlled cursor on the display; and
controlling the display to show the position of the user controlled cursor expressed with respect to the axes.

2. The computer program product according to claim 1, wherein when the code is executed the computer is caused to show the position of the user controlled cursor with respect to the axes graduations as alphanumerical or numerical figures.

3. The computer program product according to claim 1, wherein when the code is executed the computer is caused to update the position with respect to the axes, as the position of the user controlled cursor changes on the screen.

4. The computer program product according to claim 1, wherein the area defined by the axes is transparent, such that the axes can be positioned over an image on the display substantially without obscuring the image detail.

5. The computer program product according to claim 1, wherein when the code is executed the computer is caused to:
display a graphical user interface having one or more styles of boundary shape, and/or axes; and
receive a user selection of a style, wherein the boundary shape, and/or axes selected is created.

6. The computer program product according to claim 5, wherein the position of the user controlled cursor with respect to the axes graduations, is displayed according to the selected style of boundary shape and/or axes.

7. The computer program product according to claim 1, wherein when the code is executed the computer is caused to display grid lines corresponding to axis graduations to define one or more sectors within the boundary shape.

8. The computer program product according to claim 7, comprising drawing the border of the sector in which the user controlled cursor is located a different colour to the borders of the other sectors.

9. The computer program product according to claim 1, wherein when the code is executed the computer is caused to display moveable intersecting grid lines within the boundary shape to indicate the position of the user controlled cursor.

10. The computer program product according to claim 1, wherein the initial co-ordinate defines one corner of the boundary shape.

11. The computer program product according to claim 10, wherein when the code is executed the computer is caused to receive a second co-ordinate, the second co-ordinate defining a second corner of the boundary shape.

12. The computer program product according to claim 11, wherein the initial and second co-ordinate define opposing corners of a four cornered boundary shape.

13. The computer program product according to claim 1, wherein the boundary shape is a rectangle.

14. The computer program product according to claim 1, wherein the boundary shape has at least two parallel sides.

15. The computer program product according to claim 1 wherein, the boundary shape is circular or elliptical.

16. The computer program product according to claim 1, wherein the boundary shape is created such that the initial co-ordinate is located inside the boundary shape.

17. The computer program product according to claim 16, wherein the boundary shape is created in dependence on the graphical content of the region of an underlying image in which the initial co-ordinate lies.

18. A graphical user interface for controlling a display, the display having an on-screen cursor for selecting and editing parts of the display comprising:
a user interactive selector for selecting an initial display co-ordinate;
a boundary shape generator for creating a boundary shape which includes the initial co-ordinate, axes along at least two non-parallel sides of the boundary shape being displayed on screen, the axes having graduations;
a detector for receiving the position of a user controlled cursor on the display; and
a position indicator for indicating the position of the user controlled cursor expressed with respect to the axes.

19-33. (canceled)

34. A computer program product having a computer readable medium on which code is stored for controlling a computer to measure a distance on an image displayed on display device, the code when executed on the computer causing the computer to perform the steps of:
receiving a calibration start co-ordinate and a calibration end co-ordinate on the image;
calculating the calibration distance between the calibration start co-ordinate and the calibration end co-ordinate;
receiving a reference distance associated with the calibration distance;
storing the calibration distance and the reference distance;
receiving a measuring start co-ordinate and a measuring end co-ordinate defining an input distance to be converted into an output distance;
calculating the input distance between the measuring start co-ordinate and the measuring end coordinate;
converting the input distance to an output distance based on the reference distance, and outputting the result.

35. The computer program product according to claim 34, wherein when the code is executed the computer is caused to receive one or more intermediate measuring co-ordinates between the start and the end co-ordinates, wherein the input distance measured is that from the measuring start co-ordinate to the end co-ordinate, via the one or more intermediate co-ordinates.

36. The computer program product according to claim 34, wherein any of the steps for receiving a start and an end co-ordinate comprise:
providing a line drawing tool for drawing a line on the image;
receiving a user input defining a line, the end points of the line being the start and end co-ordinates respectively.

37. The computer program product according to claim 34, wherein the storing step comprises, dividing the reference distance by the calibration distance, and storing the result as a calibration factor.

38. The computer program product according to claim 37, wherein the calculating step comprises multiplying the calibration factor by the input distance.

39. A graphical user interface for measuring a distance on an image displayed on display device, comprising:
a first input mechanism for receiving a calibration start co-ordinate and a calibration end co-ordinate on the image;
a first comparator for calculating the calibration distance between the calibration start co-ordinate and the calibration end co-ordinate;
a second input mechanism for receiving a reference distance associated with the calibration distance;
a memory for storing the calibration distance and the reference distance;
a third input mechanism for receiving a measuring start co-ordinate and a measuring end co-ordinate defining an input distance to be converted into an output distance;
a second comparator for calculating the input distance between the measuring start co-ordinate and the measuring end co-ordinate;
a convertor for converting the input distance to an output distance based on the reference distance, and outputting the result.

40-44. (canceled)

45. A computer program product having a computer readable medium on which code is stored for controlling an on screen ruler, wherein when the code is executed on a computer the computer is caused to perform the steps of:
receiving an input selecting a ruler style from one or more available ruler styles;
displaying a ruler on screen in the selected ruler style;
detecting when the displayed ruler is selected by an on screen cursor;
when the ruler is selected, detecting input through which at least one of the scale, the size, or the rotation angle of the on-screen ruler can be varied.

46. The computer program product according to claim 45, comprising:
when the ruler is selected, causing pre-determined locations of the ruler to be responsive to the on screen cursor, wherein through interaction of the cursor with these locations the ruler can be re-sized and re-scaled;
detecting interaction between the on screen cursor and the pre-determined locations and altering the size or the scale of the ruler accordingly.

47. The computer program product according to claim 45, wherein when the code is executed the computer is caused to additionally provide pre-determined locations of the ruler which are responsive to interaction with the on screen cursor, and through which the ruler can be rotated.

48. The computer program product according to claim 46, wherein the pre-determined locations are arranged to be selected using the on screen cursor, and manipulated by subsequently dragging the cursor such that one or more of the size, scale and orientation of the ruler vary.

49. The computer program product according to claim 46, wherein the on screen cursor changes shape when positioned over the pre-determined locations to indicate one or more of a re-sizing function, a re-scaling function, or a rotation function.

50. The computer program product according to claim 45, wherein when the code is executed the computer is caused to display, when the ruler is rotated beyond a predetermined angle to the horizontal, any alphanumeric characters on the ruler, the right way up irrespective of the angle of rotation.

51. The computer program product according to claim 45, wherein when the code is executed the computer is caused to change the side of the ruler on which any graduations are displayed as the ruler is rotated.

52. A graphical user interface for controlling an on screen ruler, comprising:
a display showing one or more ruler styles for selection;
a ruler generator for displaying a ruler on screen according to a selected ruler style;
a selection detector for detecting when the displayed ruler is selected by an on screen cursor;
an input detector for detecting user input, when the ruler is selected, through which at least one of the scale, the size, or the rotation angle of the on-screen ruler can be varied.

53-64. (canceled)
